(19) United States
(12) Patent Application Publication
(10) Pub. No.: US 2008/0106771 A1
(43) Pub. Date: May 8, 2008

(54) PRESSING DEVICE AND SCAN APPARATUS USING THE SAME

(75) Inventor: Yi-Yu Cao, Jiangsu Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: QISDA CORPORATION, Taoyuan Shien (TW); BENQ CORPORATION, Taipei (TW)

(21) Appl. No.: 11/933,453

(22) Filed: Nov. 1, 2007

(30) Foreign Application Priority Data
Nov. 3, 2006 (TW) 95140840

(51) Int. Cl. H04N 1/04

(52) U.S. Cl. 358/474

(57) ABSTRACT

The invention discloses a pressing device and scan apparatus using the same. The scan apparatus includes an upper cover, a carriage flatbed, and a pressing device. The pressing device includes a pressing part, a frame, and a clipping part. The pressing part is disposed at a lower surface of the upper cover. The frame is connected to the upper cover. The clipping part is disposed on the frame and connected to the upper cover. A part of the clipping part connects to the pressing part for fixing a to-be-scanned object. When the upper cover is covered on the carriage flatbed, the upper cover moves down relative to the frame and brings the clipping part to move such that the clipping part is separated from the pressing part to release the to-be-scanned object, and the pressing part above the to-be-scanned object flattens the same on the carriage flatbed.

This application claims the benefit of Taiwan application Serial No. 95140840, filed Nov. 3, 2006, the subject matter of which is incorporated herein by reference.

### BACKGROUND OF THE INVENTION

1. Field of the Invention

The invention relates in general to a pressing device and scan apparatus using the same, and more particularly to a pressing device for pressing a to-be-scanned object to be completely flat, and a scan apparatus using the same.

2. Description of the Related Art

The present scanners can be mainly divided into two series: one is a scanner with a charge-coupled device (CCD) and the other is a scanner with a contact image sensor (CIS). Since the CIS scanner was produced and supplied to the consumers, due to limitation of the distance between the scan window glass and the CIS, the CIS scanner cannot scan an object in 3 dimensions. In the scan process, it is also difficult to press a document, especially a transparent document, such as a positive film (a filmstripe) or a negative film (a photographic negative), close enough to the scan window glass of the scanner to obtain a clear scanned image.

Take scanning a negative film as an example. Referring to FIG. 1, a simplified schematic diagram of a conventional film-clipping device is shown. As shown in FIG. 1, the film-clipping device 1 is used for fixing and clipping a negative film F, which in turn results in a gap with a distance d between the negative film F and the scan window glass 10. Normally, the gap distance d is only about 1 mm. However, in terms of the CIS scanner, the 1 mm gap may cause that the negative film F is not close enough to the scan window glass 10 for the scanner to catch a clear image of the negative film F. Without changing the distance between the scan window glass 10 and the CIS, in order to solve the above problem, some conventional solutions are employed and illustrated as follows.

One solution is to change a focusing position of the CIS scanner. The focusing position of the CIS scanner should be located at the upper surface of the scan window glass so as to scan a reflective document. While a transparent document is to be scanned, the focusing position can be moved to the transparent document clipped by the film-clipping device by relatively moving the scan window glass or an optical scan module of the CIS scanner. However, this solution has to design an extra fine-adjusting mechanism for the scan window glass or the optical scan module in the scanner, which increases structure complication of the whole CIS scanner.

Another solution is to bend the negative film so that the center of the negative film can be close to the scan window glass. This solution uses the flexibility of the negative film to bend the negative film, so that the center of the negative film can get close to the scan window glass. However, the drawback of this solution is that bending the negative film will easily damage it and depart its edge from the focusing position.

Besides, a detachable film-clipping device can be used in the scanner. According to Chinese patent No. 03155897.6 (publication No. CN1495657A), it discloses a film-clipping device that is divided into an upper piece and a lower piece. The lower piece is for hooking up the edge of the negative film for positioning and the upper piece is for pressing the negative film. Normally, the upper piece is fixed on the upper cover of the scanner, while the lower piece is disposed on the scan window glass as the negative film needs to be scanned. The drawback of the method is that a new component is introduced and needs to be positioned on the scan window glass by another fixing method. Moreover, the lower piece has to be removed when the reflective document is to be scanned, which makes the lower piece get lost very easily.

### SUMMARY OF THE INVENTION

The invention provides a pressing device and a scan apparatus using the same. When the upper cover is covered on the main body to scan an object, the pressing device is used to press the object to be tightly attached to the scan window glass and thus the object can be scanned in the same position as a normal reflective document. The to-be-scanned object is placed between a pressing part and a clipping part of the pressing device. When the user presses the upper cover, the to-be-scanned object is released from the position between the pressing part and the clipping part. The pressing part presses the to-be-scanned object to be completely flat on the scan window glass by an elastic force such that there is no gap between the object and the scan window glass, which prevents the above prior-art problem.

According to a first aspect of the present invention, a pressing device is provided. The pressing device is applied to a scan apparatus for scanning at least a to-be-scanned object. The scan apparatus includes an upper cover and a carriage flatbed, and the upper cover is movably disposed on the carriage flatbed. The pressing device comprises a pressing part, a frame and a clipping part. The pressing part is elastically disposed at a lower surface of the upper cover. The frame is movably connected to the upper cover. The clipping part is movably disposed on the frame and connected to the upper cover. A part of the clipping part can be connected to a lower surface of the pressing part for fixing the to-be-scanned object. When the upper cover is covered on the carriage flatbed, the upper cover can move down relative to the frame and bring the clipping part to move such that the clipping part is separated from the pressing part to release the to-be-scanned object, and at the time, the pressing part presses the to-be-scanned object to be flat on the carriage flatbed.

According to a second aspect of the present invention, a scan apparatus is provided. The scan apparatus comprises a main body, an upper cover and a pressing device. The main body has a carriage flatbed disposed at an upper surface of the main body. The upper cover is movably disposed on the main body and capable of being selectively covered on the main body. The pressing device comprises a pressing part, a frame and a clipping part. The pressing part is elastically disposed at a lower surface of the upper cover and located between the upper cover and the carriage flatbed. The frame is movably connected to the upper cover. The clipping part is movably disposed on the frame and connected to the lower surface of the upper cover. A part of the clipping part can be connected to a lower surface of the pressing part for fixing the to-be-scanned object. When the upper cover is covered on the main body, the upper cover moves down relative to the frame and brings the clipping part to move such that the clipping part is separated from the pressing part to release the to-be-scanned object, and the pressing part presses the to-be-scanned object to be flat on the carriage flatbed.

The invention will become apparent from the following detailed description of the preferred but non-limiting embodiments. The following description is made with reference to the accompanying drawings.

### BRIEF DESCRIPTION OF THE DRAWINGS

FIG. 1 is a simplified schematic diagram of a conventional film-clipping device;

FIG. 2A is a schematic diagram of a scan apparatus according to a preferred embodiment of the invention;

FIG. 2B is a cross-sectional view of a pressing device in FIG. 2A;

FIG. 3 is a schematic diagram of the disposition of the pressing part in FIG. 2B relative to the negative film;

FIG. 4 is a schematic diagram of the clipping part with other structure; and

FIGS. 5A˜5C are schematic diagrams of operations of the pressing device in FIG. 2B.

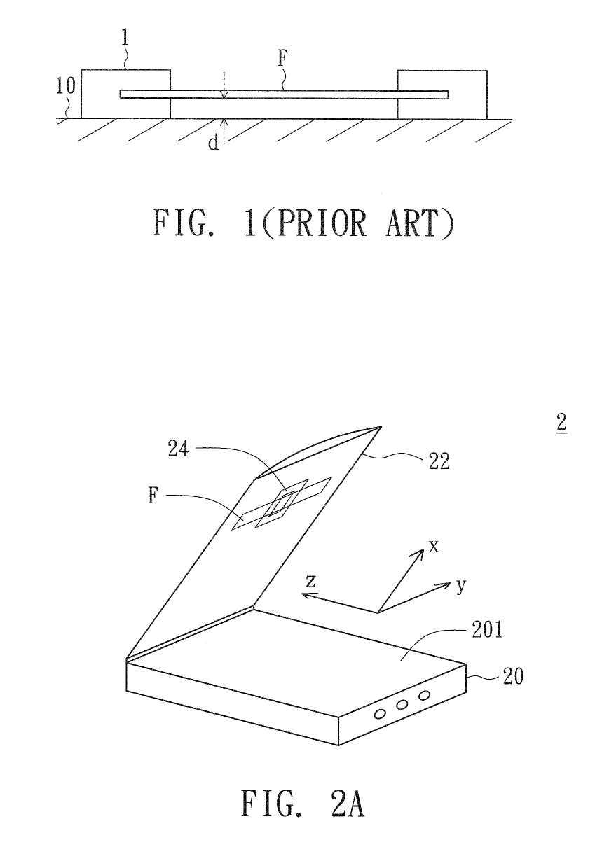

### DETAILED DESCRIPTION OF THE INVENTION

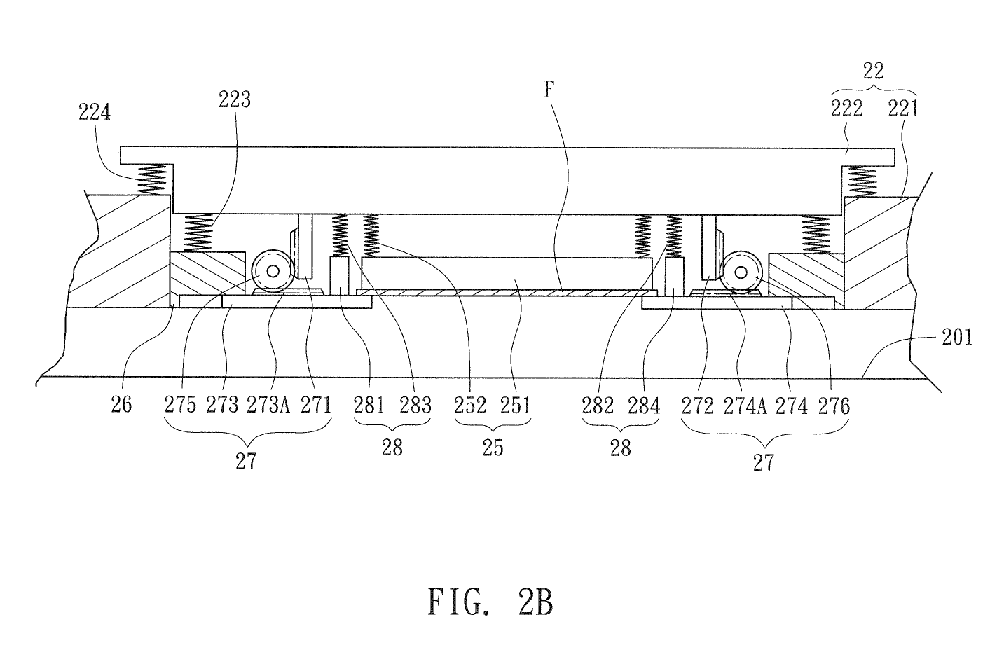

Referring to FIGS. 2A and 2B, a schematic diagram of a scan apparatus according to a preferred embodiment of the invention and a cross-sectional view of a pressing device in FIG. 2A are respectively shown. As shown in FIG. 2A, a scan apparatus 2 includes a main body 20, an upper cover 22 and a pressing device 24. The upper cover 22 is movably disposed on the main body 20 and can be selectively covered on the main body 20. As shown in FIG. 2B, the pressing device 24 includes a pressing part 25, a frame 26 and a clipping part 27. The pressing part 25 is elastically disposed at a lower surface of the upper cover 22 and located between the upper cover 22 and a carriage flatbed 201. The frame 26 is movably connected to the upper cover 22. The clipping part 27 is movably disposed on the frame 26 and connected to the lower surface of the upper cover 22. A part of the clipping part 27 can contact the lower surface of the pressing part 25 to fix at least a to-be-scanned object. When the upper cover 22 is covered on the main body 20, the upper cover 22 can move down relative to the frame 26 and bring the clipping part 27 to move such that the clipping part 27 is separated from the pressing part 25 to release the to-be-scanned object. At the time, the pressing part 25 presses the to-be-scanned object to be flat on the carriage flatbed 210.

In the embodiment, the to-be-scanned object is exemplified to be a transparent document, such as the negative film F for illustration.

The upper cover 22 can be connected to the main body 20 via a rotational pivot (not shown in the figure). However, the upper cover 22 can also be slidably connected to the main body 20, and a to-be-scanned document is put in for scan after sliding out the upper cover. Besides, the upper cover 22 and the main body 20 can also be two independent components. The upper cover 22 is combined with the main body 20 for the scan operation.

As shown in FIG. 2A, in the embodiment, the upper cover 22 is exemplified to be rotatably disposed on the main body 20 for illustration. The upper cover 22 can be rotated relative to the main body 20 to cover on the main body 20, and the carriage flatbed 201 is, for example, the scan window glass of the scan apparatus 2. When the negative film F is pressed flat on the carriage flatbed 201, the optical scan module (not shown in the figure) located under the carriage flatbed 201 can start to scan the negative film F.

As shown in FIG. 2B, the upper cover 22 includes a first cover casing 221 and a second cover casing 222 coupled to each other. The second cover casing 222 can slide in the first cover casing 221. A light source (not shown in the figure) is usually disposed in the second cover casing 222 for providing the backlight required for scanning the transparent document (the negative film F in the embodiment).

The frame 26 is slidably connected to the upper cover 22 for example. In the embodiment, the frame 26 is exemplified to be connected to the second cover casing 222 of the upper cover 22 for illustration. The frame 26 can be slidably connected to the second cover casing 222. A guiding socket can be designed on the frame 26 such that the second cover casing 222 can slide in the guiding socket up and down. Or the frame 26 can be elastically connected to the second cover casing 222. No matter which connection way is used, when the upper cover 22 is covered on the carriage flatbed 201, the frame 26 has to be fixed in order that the second cover casing 222 can bring the clipping part 27 to move. Therefore, practically, the frame 26 can be fixed on the first cover casing 221 or the frame 26 and the first cover casing 221 can be manufactured into a unity. When the upper cover 22 is covered on the main body 20, the frame 26 together with the first cover casing 221 will be fixed on the main body 20. Preferably, an elastic element 223 can be disposed between the frame 26 and the second cover casing 222 such that the second cover casing 222 can return to its original position via an elastic force of the elastic element 223. Besides, at least an elastic element 224 is preferably disposed between the first cover casing 221 and the second cover casing 222 for supplying an elastic force to maintain a distance between the first cover casing 221 and the second cover casing 222 when no external force is applied. The elastic elements 223 and 224 are elastic objects, such as sponge, rubber or springs. The elastic elements are exemplified to be springs in the embodiment for illustration.

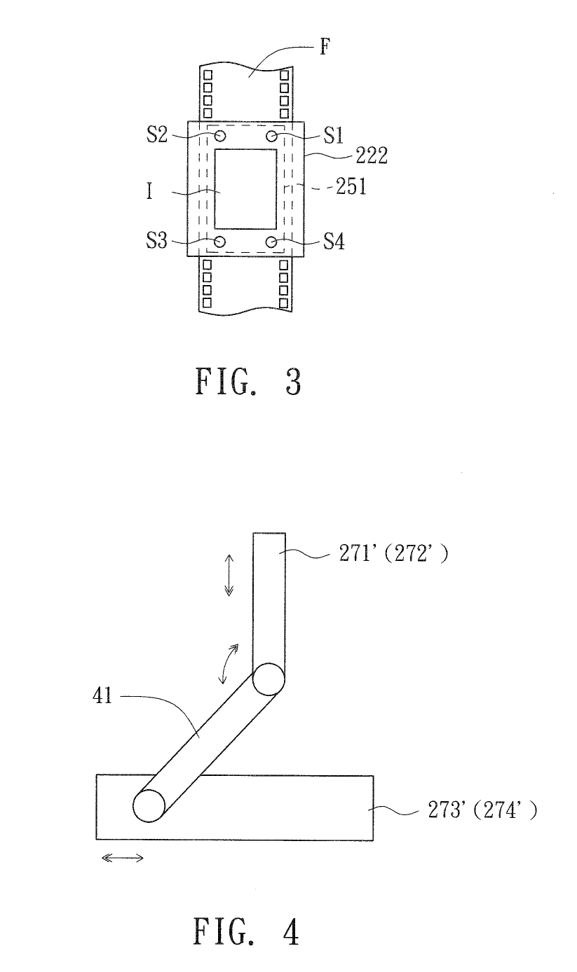

The pressing part 25 includes a transparent plate 251 and at least an elastic element 252. The elastic element 252 is connected to the transparent plate 251 and the second cover casing 222 of the upper cover 22. Referring to FIG. 3 at the same time, a schematic diagram of the disposition of the pressing part in FIG. 2B relative to the negative film F is shown. As shown in FIG. 3, the transparent plate 251 is a rectangular plate for instance. The transparent plate 251 is corresponding to a scan region I of the negative film F. Four springs S1˜S4 are respectively disposed at four edge of the scan region I. When the four springs S1˜S4 apply forces to the transparent plate 251, the transparent plate 251 will be pressed on the negative film F.

As shown in FIG. 2B, the clipping part 27 includes a first input piece 271, a second input piece 272, a first clipping piece 273 and a second clipping piece 274. The first input piece 271 and the second input piece 272 are disposed at the lower surface of the second cover casing 222 of the upper cover 22 and located at two sides of the pressing part 25. The first clipping piece 273 and the second clipping piece 274 are slidably disposed on the frame 26 and connected to the first input piece 271 and the second input piece 272, respectively. The first clipping piece 273 and the second clipping piece 274 can also be combined with the frame 26 via the design of guiding sockets. For example, two guiding sockets are designed on the frame 26 for disposing the first clipping piece 273 and the second clipping piece 274 such that the two pieces 273 and 274 can slide in the guiding sockets. A part of the first clipping piece 273 and a part of the clipping piece 274 are disposed against the lower surface of the pressing part 25. When the first input piece 271 and the second input piece 272 move down and bring the first clipping piece 273 and the second clipping piece 274 to move outward, the first clipping piece 273 and the second clipping piece 274 are separated from the pressing part 25 to release the negative film F.

There can be many ways of connection between the first input piece 271 and the first clipping piece 273 and between the second input piece 272 and the second clipping piece 274. As long as the moving directions of the first input piece 271 and the second input piece 272 are declined by an angle (preferably 90 degrees) relative to the moving directions of the first clipping piece 273 and the second clipping piece 274, any alternative is not apart from the scope of the invention. As shown in FIG. 2B, the first input piece 271 and the second input piece 272 can be racks. The first clipping piece 273 can be designed to have a first tooth part 273A and the second clipping piece 274 can be designed to have a second tooth part 274A. The clipping part 27 further includes a first gear wheel 275 and a second gear wheel 276 disposed on the frame 26 (The axes of the first gear wheel 275 and the second gear wheel 276 are disposed on the frame 26). The first gear wheel 275 is for coupling to the first input piece 271 and the first tooth part 273A, and the second gear wheel 276 is for coupling to the second input piece 272 and the second tooth part 274A. The ways of operation between the elements will be illustrated accompanied with drawings as follows.

In addition to the gear wheels and the racks, bar sets can be also used to perform the clipping and releasing operations of the clipping part. Referring to FIG. 4, a schematic diagram of the clipping part with other structure is shown. As shown in FIG. 4, the first input piece 271′ (the second input piece 272′) and the first clipping piece 273′ (the second clipping piece 274′) are be connected via a bar 41. Because the first input piece 271′ can only move vertically and the first clipping piece 273′ can only move horizontally, when the first input piece 271′ moves downward, the bar 41 will rotate clockwise to bring the first clipping piece 273′ to move left, vice versa. The gear wheels and racks are taken as an example for illustration in the embodiment.

Preferably, the pressing device 24 further includes a position-limiting part 28 (as shown in FIG. 2B), which is elastically disposed on the lower surface of the upper cover 22, located adjacent to the pressing part 25 and disposed against a part of the clipping part 27. The position-limiting part 28 includes at least a position-limiting plate and at least an elastic element. The elastic element is for connecting the position-limiting plate and the second cover casing 222 of the upper cover 22. Two position-limiting plates 281 and 282 and two elastic elements 283 and 284 are exemplified for illustration in the embodiment. When the second cover casing 222 of the upper cover 22 moves down relative to the frame 26 and brings the clipping part 27 to move, the position-limiting part 28 is separated from the clipping part 27 to go against the carriage flatbed 201 and position the negative film F.

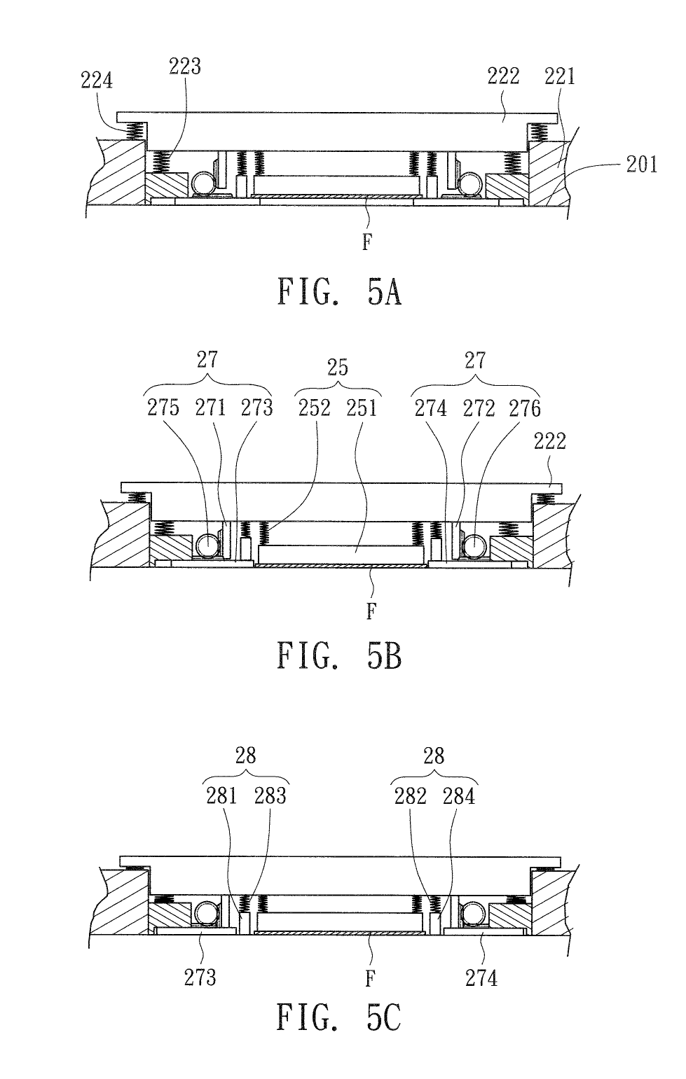

Referring to FIGS. 5A˜5C, schematic diagrams of operations of the pressing device in FIG. 2B are shown. When the upper cover 22 is rotated to cover on the main body 20, as shown in FIG. 5A, the first cover casing 221 is covered on the carriage flatbed 201 of the main body 20, and under the function of the elastic elements 223 and 224, the second cover casing 222 keeps a distance from the first cover casing 221. The pressing device 24 clips the negative film F and thus the user has to press the second cover casing 222 to release the negative film F. When the user presses the second cover casing 222 downward, as shown in FIG. 5B, the second cover casing 222 brings the first input piece 271 and the second input piece 272 to move downward. At the time, the first input piece 271 and the second input piece 272 respectively bring the first gear wheel 275 and the second gear wheel 276 to rotate slightly and thus bring the first clipping piece 273 and the second clipping piece 274 to move in two opposite horizontal directions and be separated from the pressing part 25. After the clipping part 27 is separated from the pressing part 25, the confinement of the first clipping piece 273 and the second clipping piece 274 on the transparent plate 251 of the pressing part 25 is removed, such that the negative film F will automatically fall down on the carriage flatbed 201. Moreover, because the elastic element 252 located above the transparent plate 251 applies the elastic force to the transparent plate 251 to move it downward, the negative film F will be pressed flat on the carriage flatbed 201 by the transparent plate 251. When the user keeps applying a force downward, as shown in FIG. 5C, the first clipping piece 273 and the second clipping piece 274 keep moving in the opposite horizontal directions to separate from the position-limiting part 28. When the position-limiting parts 281 and 282 are not confined by the first clipping piece 273 and the second clipping piece 274, the position-limiting plates 281 and 282 move downward due to the elastic forces of the elastic elements 283 and 284 to go against the carriage flatbed 201 in order to position the negative film F and complete the pressing operation.

When the negative film F is completely pressed flat on the carriage flatbed 201 (scan window glass), the above problem of a CIS scanner due to limitation of the distance between the scan window and the CIS can be resolved. When the scan of the negative film F is completed, it needs only to move out the first cover casing 221 and the negative film F is left on the carriage flatbed 201 for the user to take out. After the first cover casing 221 is removed, it needs only to slightly apply a force on the second cover casing 222 or the pressing part 25 to move it relative to the first cover casing 221 for the components such as the first clipping piece 273, the second clipping piece 274 and the position-limiting part 28 to return to their original positions. When another negative film is to be scanned, the negative film is disposed on the pressing part 25 and the clipping part 27 similarly, and then the above steps are repeated. Because the negative film is fixed in the pressing device 24, when the upper cover 22 is covered on the main body 20, the negative film F will not move randomly, or loose easily.

The above pressing device 24 can be practically applied to any product that has to fix one object tightly to another object. As applied to the scanner, especially the CIS scanner, the above problem due to limitation of small distance between the scan window glass and the CIS can be effectively resolved.

In the pressing device and scan apparatus using the same disclosed by the above embodiment of the invention, by pressing the upper cover, the pressing device is forced to release the negative film and press the negative film to be flat on the scan window glass of the scan apparatus. The negative film is disposed between the pressing part and the clipping part. To scan the negative film, it needs only to press down the upper cover, and the clipping part will be separated from the pressing part. The pressing part will then press on the negative film to achieve the purpose of making the negative film to be flat on the scan window glass.

Although the negative film is exemplified for illustration in the invention, the pressing device of the invention can also be used to scan other transparent documents or other to-be-scanned objects to achieve the purpose of easily putting in and taking out, or positioning the to-be-scanned object.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pressing device, applied to a scan apparatus for scanning at least a to-be-scanned object, the scan apparatus includes an upper cover and a carriage flatbed, the upper cover movably disposed on the carriage flatbed, the pressing device comprising:
a pressing part, elastically disposed at a lower surface of the upper cover;
a frame, movably connected to the upper cover; and
a clipping part, movably disposed on the frame and connected to the upper cover, wherein a part of the clipping part can be connected to a lower surface of the pressing part for fixing the to-be-scanned object;
wherein when the upper cover is covered on the carriage flatbed, the upper cover can move down relative to the frame and bring the clipping part to move such that the clipping part is separated from the pressing part to release the to-be-scanned object, and at the time, the pressing part presses the to-be-scanned object to be flat on the carriage flatbed.

2. The pressing device according to claim 1, wherein the frame is slidably connected to the upper cover.

3. The pressing device according to claim 2, wherein the upper cover has a first cover casing and a second cover casing coupled to each other, the second cover casing can slide in the first cover casing and the second cover casing is slidably connected to the frame.

4. The pressing device according to claim 3, wherein the frame is fixed to the first cover casing or the frame and the first cover casing are manufactured into a unity.

5. The pressing device according to claim 3, further comprising:
at least an elastic element, disposed between the first cover casing and the second cover casing.

6. The pressing device according to claim 1, wherein the pressing part comprises a transparent plate and at least an elastic element, and the elastic element is connected to the upper cover and the transparent plate.

7. The pressing device according to claim 1, wherein the clipping part comprises:
a first input piece and a second input piece, fixed to the lower surface of the upper cover and located at two sides of the pressing part; and
a first clipping piece and a second clipping piece, slidably disposed on the frame and respectively connected to the first input piece and the second input piece, wherein a part of the first clipping piece and a part of the second clipping piece are disposed against the lower surface of the pressing part.

8. The pressing device according to claim 7, wherein the moving direction of the first input piece is substantially vertical to the moving direction of the first clipping piece, and the moving direction of the second input piece is substantially vertical to the moving direction of the second clipping piece.

9. The pressing device according to claim 8, wherein the first input piece is a first rack, the second input piece is a second rack, the first clipping piece has a first tooth part and the second clipping part has a second tooth part, the clipping part further comprises:
a first gear wheel and a second gear wheel, rotatably disposed on the frame, wherein the first gear wheel is coupled to the first rack and the first tooth part, and the second gear wheel is coupled to the second rack and the second tooth part.

10. The pressing device according to claim 8, wherein the first input piece is a first bar, the second input piece is a second bar, and the clipping part further comprises:
a third bar and a fourth bar, wherein two ends of the third bar are respectively connected to the first bar and the first clipping piece, and two ends of the fourth bar are respectively connected to the second bar and the second clipping piece.

11. The pressing device according to claim 1, further comprising:
a position-limiting part, elastically disposed at the lower surface of the upper cover, and adjacent to the pressing part, wherein the position-limiting part is disposed against a part of the clipping part;
wherein when the upper cover moves down relative to the frame and brings the clipping part to move, the position-limiting part is separated from the clipping part and disposed against the carriage flatbed to fix a position of the to-be-scanned object.

12. The pressing device according to claim 11, wherein the position-limiting part comprises at least a position-limiting plate and at least an elastic element, the elastic element is connected to the upper cover and the position-limiting plate.

13. A scan apparatus, comprising:
a main body, having a carriage flatbed disposed at an upper surface of the main body;
an upper cover, movably disposed on the main body and capable of being selectively covered on the main body; and
a pressing device, comprising:
a pressing part, elastically disposed at a lower surface of the upper cover and located between the upper cover and the carriage flatbed;
a frame, movably connected to the upper cover; and
a clipping part, movably disposed on the frame and connected to the lower surface of the upper cover, wherein a part of the clipping part can be connected to a lower surface of the pressing part for fixing the to-be-scanned object;
wherein when the upper cover is covered on the main body, the upper cover moves down relative to the frame and brings the clipping part to move such that the clipping part is separated from the pressing part to release the to-be-scanned object, and the pressing part presses the to-be-scanned object to be flat on the carriage flatbed.

14. The scan apparatus according to claim 13, wherein the frame is slidably connected to the upper cover.

15. The scan apparatus according to claim 14, wherein the upper cover has a first cover casing and a second cover casing coupled to each other, the second cover casing can slide in the first cover casing and the second cover casing is slidably connected to the frame.

16. The scan apparatus according to claim 15, wherein the frame is fixed to the first cover casing or the frame and the first cover casing are manufactured into a unity.

17. The scan apparatus according to claim 15, wherein the pressing device further comprises at least an elastic element connected to the first cover casing and the second cover casing.

18. A scan apparatus, comprising:
a main body, having a carriage flatbed disposed at an upper surface of the main body;
an upper cover, movably disposed on the main body and capable of being selectively covered on the main body; and
the pressing device of claim 1.

19. The scan apparatus according to claim 18, wherein the carriage flatbed is scan window glass.

20. The scan apparatus according to claim 18, wherein the upper cover is rotatably connected to the main body.
